(19) United States
(12) Patent Application Publication
(10) Pub. No.: US 2025/0307664 A1
(43) Pub. Date: Oct. 2, 2025

(54) METHOD TO ENCODE SET BY PRIME NUMBER TO ENCODE SET IN FIXED DIMENSION AND PARALLELLY CALCULATED BY GPU

(71) Applicant: Advanced Micro Devices, Inc., Santa Clara, CA (US)

(72) Inventor: PanMi Wu, Shanghai (CN)

(21) Appl. No.: 18/620,292

(22) Filed: Mar. 28, 2024

(51) Int. Cl. G06N 5/022

(52) U.S. Cl. CPC G06N 5/022

(57) ABSTRACT

An apparatus and method for efficiently encoding tokens of a knowledge graph. In various implementations, a computing system includes a includes a processing circuit and a memory. The memory stores the instructions of an application that relies on a data model such as a large language model (LLM) to process natural language processing (NLP) tasks that analyze and extract meaning and relationships from text provided by a user's input. The processing circuit receives a full tokens list of a knowledge graph and receives set relationships for the full tokens list. When executing the application, the processing circuit assigns unique contiguous prime numbers to the tokens of the full tokens list and generates encoded values for the tokens based at least on the assigned prime numbers. The processing circuit provides the encoded full tokens list to the data model.

### BACKGROUND

### Description of the Relevant Art

Multilayer networks are used in a variety of applications in a variety of fields such as physics, chemistry, biology, engineering, social media, finance, and so on. Some of the applications that use multilayer networks are text recognition, image recognition, speech recognition, and recommendation systems. Multilayer networks classify data in order to provide an output value representing a prediction when given a set of inputs. The multilayer network uses multiple hidden layers of nodes (or neurons) between an input layer and an output layer of nodes. Each node has a specified activation function and a specified weight that is determined during training of the multilayer network. The nodes of the hidden layers, other than the last hidden layer, are not directly connected to the output layer.

In some implementations, the multilayer network processes a workload that includes natural language processing (NLP) tasks that analyze and extract meaning and relationships from text provided by a user's input. A result is generated, which can be a predicted categorization, a predicted response or resolution, or a predicted recommendation. Organizations have access to large volumes of text data unavailable outside of the organization but provide relevant information for the multilayer network to fine tune the generated results. Organizations can generate and use knowledge graphs to provide relevant information. Knowledge graphs provide interlinked descriptions of tokens in the graph. A token is a node of the graph representing any one of objects, events, situations, or concepts. However, as the amount of relevant information increases, the size and number of tokens also increase. Therefore, system cost increases to provide hardware resources that can support the large number and sizes of tokens and process the relatively high number of computations in a suitable timeframe. If an organization cannot support the high cost of using the multilayer network, then the organization is unable to benefit from the multilayer network.

In view of the above, efficient methods and apparatuses for efficiently encoding tokens of a knowledge graph are desired.

### BRIEF DESCRIPTION OF THE DRAWINGS

FIG. 1 is a generalized diagram of a computing system that efficiently encodes tokens of a knowledge graph.

FIG. 2 is a generalized diagram of a knowledge graph.

FIG. 3 is a generalized diagram of an apparatus that efficiently encodes tokens of a knowledge graph.

FIG. 4 is a generalized diagram of an apparatus that efficiently encodes tokens of a knowledge graph.

FIG. 5 is a generalized diagram of a method for efficiently encoding tokens of a knowledge graph.

FIG. 6 is a generalized diagram of an apparatus that performs a subset type of set operation with efficiently encoded tokens of a knowledge graph.

FIG. 7 is a generalized diagram of an apparatus that performs a union type of set operation with efficiently encoded tokens of a knowledge graph.

FIG. 8 is a generalized diagram of an apparatus that performs an intersect type of set operation with efficiently encoded tokens of a knowledge graph.

FIG. 9 is a generalized diagram of an apparatus that performs a superset type of set operation with efficiently encoded tokens of a knowledge graph.

FIG. 10 is a generalized diagram of an apparatus that performs overflow management with efficiently encoded tokens of a knowledge graph.

FIG. 11 is a generalized diagram of a method for efficiently encoding tokens of a knowledge graph.

FIG. 12 is a generalized diagram of a computing system that efficiently encodes tokens of a knowledge graph.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently encoding tokens of a knowledge graph are contemplated. In various implementations, a computing system includes a parallel data processing circuit and a memory. The parallel data processing circuit uses a parallel data microarchitecture such as a single instruction multiple data (SIMD) parallel microarchitecture. The memory stores at least the instructions (or translated commands) of a parallel data application that relies on a data model such as a large language model (LLM). The parallel data application processes natural language processing (NLP) tasks that analyze and extract meaning and relationships from text provided by a user's input. The parallel data application includes a token encoding algorithm. The parallel data processing circuit (or processing circuit) receives a full tokens list of a knowledge graph and receives set relationships for the full tokens list.

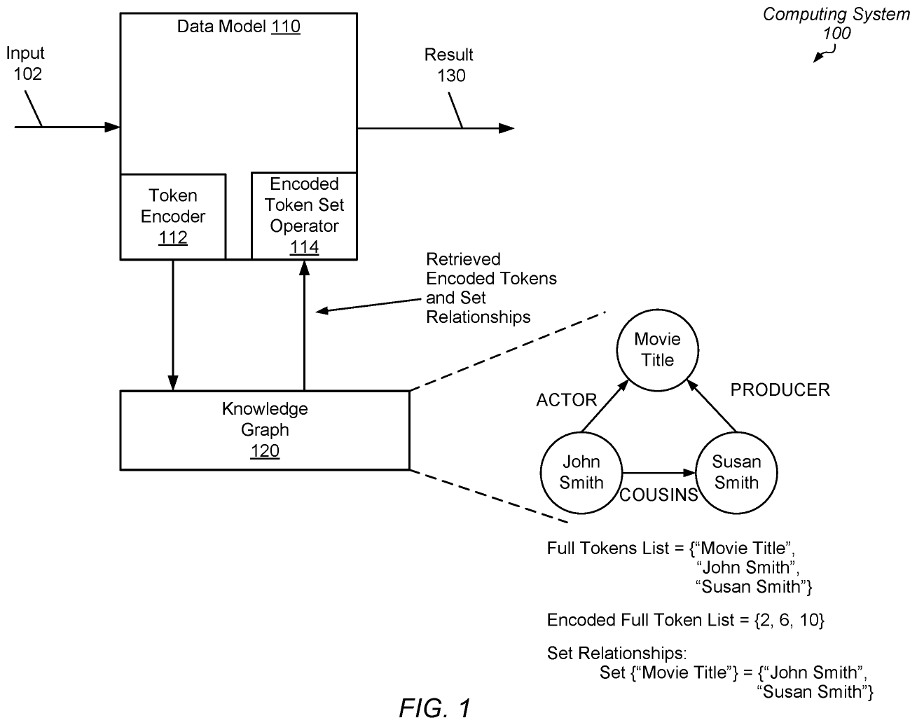

When the processing circuit executes the instructions of the token encoding algorithm, the processing circuit assigns unique contiguous prime numbers to the tokens of the full tokens list. For each of the tokens, the processing circuit generates an encoded value by multiplying the assigned prime number of the token and the assigned prime number(s) of corresponding superset(s) indicated by the set relationships. The processing circuit provides the encoded full tokens list to the data model. By encoding the tokens based on unique contiguous prime numbers, the processing circuit additionally encodes the relationships, rather than providing separate encoded values for edges of the knowledge graph. Consequently, the processing circuit is able perform set operations with the encoded values in a parallel manner. Further details of these techniques to efficiently encoding tokens of a knowledge graph are provided in the following description of FIGS. 1-12.

Turning now to FIG. 1, a generalized diagram is shown of a computing system 100. Computing system 100 includes a data model 110 and knowledge graph 120. Although data model 110 is shown to include token encoder 112 and encoded token set operator 114, in other implementations, these components are separate components or components incorporated within knowledge graph 120. In various implementations, data model 110 is a machine learning data model that utilizes a multilayer network. In some implementations, the workload that generates input 102 includes natural language processing (NLP) tasks that allow server computers executing the data model 110 to analyze and extract meaning and relationships from text provided by input 102. The server computers executing the data model 110 generate result 140, which can be a predicted categorization, a predicted response or resolution, or a predicted recommendation based on information provided by input 102 and knowledge graph 130. Organizations have access to large volumes of voice and text data from various communication sources such as web browsers, emails, documents and archived conference papers, emails, and more. The organizations have server computers execute the data model 110 to analyze the large amount of data, receive user queries, such as input 102, and generate result 140.

One example of input 102 is a user query that includes a user identifier (ID) and a movie title that has a corresponding item ID, and server computers that execute data model 110 generate result 140 that is a selection (mouse click) probability on another movie title present on a web page. Another example of input 102 is a subject line of an email, and server computers that execute data model 110 generate result 140 that is a categorization of the mail such as spam. Yet another example of input 102 is a user query in the healthcare field directed to the treatment of diabetes, and server computers executing the data model 110 generate result 140 that is an initial screening for diabetes or a treatment recommendation. Data model 110 can receive, as textual information, the user's medical history, lifestyle factors, and blood sugar data. Implemented as a large language model (LLM), data model 110 can have access to more than 6 billion parameters including vocabulary words in multiple languages such as English and Chinese. A further example of input 102 is a user query in the healthcare field directed to questions about known drugs and medicines and possible effects on diseases. When executing the instructions of data model 110, server computers access information from literature and databases to predict interactions between medicines and diseases.

To fine tune the result 140 generated by data model 110, data model 110 accesses knowledge graph 130 via token encoder 112. As used herein, a “knowledge graph” refers to a data structure defining a graph that represents a relationship between tokens. Knowledge graph 130 provides interlinked descriptions of the tokens in the graph. A token is a node of the graph representing any one of objects, events, situations, or concepts. An edge between two tokens represents a relationship between the two tokens. In the illustrated implementation, a simplified example of knowledge graph 130 is provided that includes three tokens labeled “Movie Title,” “John Smith,” and “Susan Smith.” The relationship between the tokens “Movie Title” and “John Smith” is Actor. The relationship between the tokens “Movie Title” and “Susan Smith” is Producer. The relationship between the tokens “John Smith” and “Susan Smith” is Cousins. The set relationships include a superset named “Movie Title” that includes the tokens “John Smith” and “Susan Smith.” As shown, token encoder 112 has encoded the parsed text values of the tokens in knowledge graph 120 into positive, non-zero integers. Here, the token “Movie Title” is encoded into the positive, non-zero integer 2, the token “John Smith” is encoded into the positive, non-zero integer 6, and the token “Susan Smith” is encoded into the positive, non-zero integer 10.

The encoding method used by token encoder 112 generates a numerical value (e.g., non-zero, positive integer) to represent the tokens, and maintains the set relationships in knowledge graph 120. Since the set relationships are maintained in the encoded tokens, and not in the edges, the later set operations performed by encoded token set operator 114 are performed in a parallel manner, rather than a serialized manner. When set relationships are encoded in the edges, rather than in the encoded tokens, the set operations cannot be executed in a parallel manner.

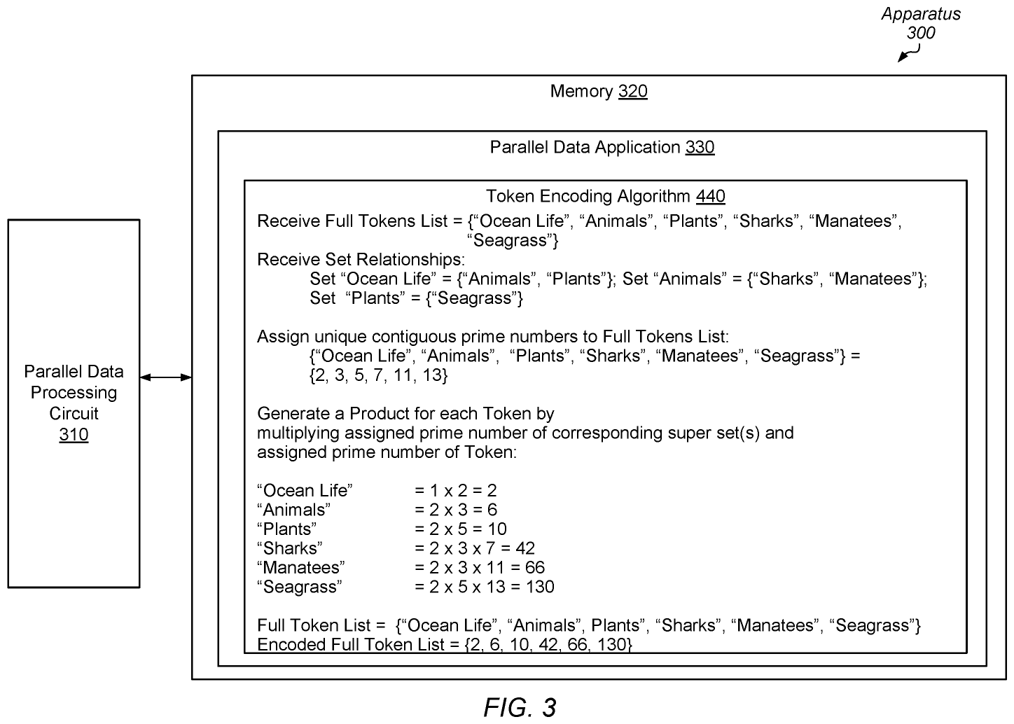

In some implementations, data model 110 also sends a set operator to knowledge graph 130 indicating one or more set operations to perform on the tokens. In other implementations, encoded token set operator 114 receives one or more set operations to perform on the tokens. Examples of the set operations are a union operation, an intersect (or intersection) operation, a subset operation, and a superset operation. In various implementations, token encoder 112 generates the numerical values representing the tokens by relying on prime numbers. Prime numbers are positive integers that are divisible by themselves and the integer 1. In other words, prime numbers have only two factors, which are itself and the integer 1. Further details of encoding the tokens are provided in the description of apparatuses 300-400 and 600-1000 (of FIGS. 3-4 and 6-10).

In various implementations, data model 110 includes a large language model (LLM) that utilizes a machine learning data model for natural language processing (NLP) tasks. The LLM includes a neural network, such as a transformer neural network, which is trained with large datasets. The transformer neural network processes data by tokenizing input 102 using token encoder 112, and then performing mathematical operations to discover relationships between tokens. Unlike recurrent neural networks (RNN) that sequentially process inputs, transformer neural networks process data in a parallel manner allowing parallel data processing circuits to efficiently execute the data model 110 and reduce training time and inference time.

In various implementations, input 102 is a natural language text input, and data model 110 receives input 102, parses the input 102, and sends a query that includes the parsed text values to knowledge graph 130. Knowledge graph 120 can include missing background knowledge to data model 110. For example, knowledge graph 120 can include information specific to a particular organization not readily available to data model 110. Token encoder 112 encodes the parsed text values into positive, non-zero integers. As described earlier, encoded token set operator 114 receives one or more set operations to perform on the tokens. Examples of the set operations are a union operation, an intersect (or intersection) operation, a subset operation, and a superset operation. Using the neural network layers of data model 110 and the information provided by knowledge graph 120, indications specifying relationships between words of a sequence or a full sentence of input 102 are generated, which are used to understand the user's intent with the text input.

In some implementations, the instructions of algorithms implementing the functionality of data model 110 are stored in lower-level memory such as a lower-level cache (e.g., a level three, L3, cache), system memory, disk storage, or remote memory accessed via a network. The information characterizing the relationships and tokens of knowledge graph 120 are stored in similar locations. One or more processing circuits execute the instructions of data model 110, token encoder 112 and encoded token set operator 114. Examples of the processing circuit are a general-purpose processing circuit, such as a multi-core central processing unit (CPU), an application specific integrated circuit (ASIC), a field programmable array (FPGA), a digital signal processor (DSP), a parallel data processing circuit, such a graphics processing unit (GPU), or other. In an implementation, the processing circuits are implemented on separate integrated circuits such as different processing units (dies) of a system on a chip (SoC), a multichip module (MCM), or other.

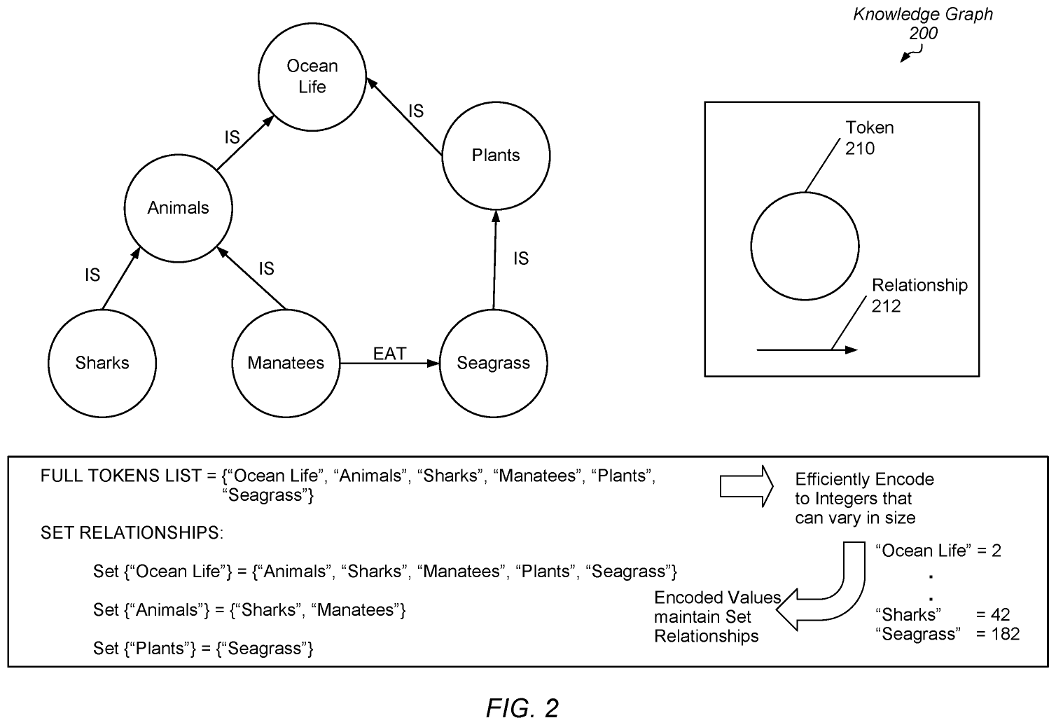

Turning now to FIG. 2, a generalized diagram is shown of a knowledge graph 200. Knowledge graph 200 includes tokens 210 and relationships 212. Each one of tokens 210 is a node of knowledge graph 200 representing any one of objects, events, situations, or concepts. As shown, knowledge graph 200 six tokens labeled “Ocean Life,” “Animals,” “Plants,” “Sharks,” “Manatees,” and “Seagrass.” The relationship between the tokens includes either “IS” or “EAT.” For example, the relationship between the token “Ocean Life” and the token “Animals” is IS. The relationship between the token “Manatee” and the token “Seagrass” is EAT. The set relationships include a superset named “Ocean Life” that includes the tokens “Animals,” “Plants,” “Sharks,” “Manatees,” and “Seagrass.” The set relationships also include a superset named “Animals” that includes the tokens “Sharks” and “Manatees.” The set relationships also include a superset named “Plants” that includes the token “Seagrass.” It is noted that the full tokens list, the supersets and the set relationships list the tokens in an order flowing from the top of knowledge graph 200 to the bottom of knowledge graph 200, and then flowing from left to right in knowledge graph 200.

As shown, a token encoder has encoded the text values of the tokens in knowledge graph 200 into positive, non-zero integers. Here, the token “Ocean Life” is encoded into the positive, non-zero integer 2, the token “Sharks” is encoded into the positive, non-zero integer 42, and the token “Seagrass” is encoded into the positive, non-zero integer 182. The encoding method generates a numerical value (e.g., non-zero, positive integer) to represent the tokens, and maintains the set relationships in knowledge graph 200. Since the set relationships are maintained in the encoded tokens, and not in the edges, the set operations performed later are performed in a parallel manner, rather than a serialized manner. When set relationships are encoded in the edges, rather than in the encoded tokens, the set operations cannot be executed in a parallel manner. Examples of the set operations are a union operation, an intersect (or intersection) operation, a subset operation, and a superset operation. In various implementations, a token encoder generates the numerical values representing the tokens by relying on prime numbers. Prime numbers are positive integers that are divisible by themselves and the integer 1. In other words, prime numbers have only two factors, which are itself and the integer 1. Further details of encoding the tokens are provided in the description of apparatuses 300-400 and 600-1000 (of FIGS. 3-4 and 6-10).

Referring to FIG. 3, a generalized diagram is shown of an apparatus 300 for efficiently encoding tokens of a knowledge graph. As shown, apparatus 300 includes a parallel data processing circuit 310 and memory 320. Parallel data processing circuit 310 uses a parallel data microarchitecture such as a single instruction multiple data (SIMD) parallel microarchitecture. Examples of parallel data processing circuit 310 are a graphics processing unit (GPU), a digital signal processing circuit (DSP), a field programmable gate array (FPGA), an application specific integrated circuit (ASIC), and so forth. In some implementations, a general-purpose processing circuit translates instructions of parallel data function calls of an application to commands that are executable by parallel data processing circuit 310. Other components of apparatus 300 such as a bus or communication fabric, clock generating circuitry, a power controller, input/output (I/O) interfaces, and other types of processing circuits are not shown for ease of illustration.

In some implementations, memory 320 is system memory implemented by one or more memory devices, which are representative of any type of memory devices. For example, the type of memory in memory devices includes Dynamic Random Access Memory (DRAM), Static Random Access Memory (SRAM), NAND Flash memory, NOR flash memory, Ferroelectric Random Access Memory (FeRAM), or otherwise. In other implementations, memory 320 is a dedicated, local memory of parallel data processing circuit 310. Memory 320 stores at least the instructions (or translated commands) of parallel data application 330. Parallel data application 330 includes token encoding algorithm 340. When parallel data processing circuit 310 executes the instructions (or translated commands) of token encoding algorithm 340, parallel data processing circuit 310 receives a full tokens list and the corresponding set relationships and generates an encoded full token list relying on prime numbers.

In the illustrated implementation, parallel data processing circuit 310 (or processing circuit 310) receives the full tokens list that includes tokens labeled “Ocean Life,” “Animals,” “Plants,” “Sharks,” “Manatees,” and “Seagrass.” These tokens represent any text token to be used in a data model such as a large language model (LLM) or other. In the illustrated implementation, processing circuit 310 receives set relationships that include a superset named “Ocean Life” that includes the tokens “Animals,” “Plants,” “Sharks,” “Manatees,” and “Seagrass.” The set relationships also include a superset named “Animals” that includes the tokens “Sharks” and “Manatees.” The set relationships also include a superset named “Plants” that includes the token “Seagrass.” It is noted that the full tokens list, the supersets and the set relationships list the tokens in an order flowing from the top of a corresponding knowledge graph (such as knowledge graph 200) to the bottom of the knowledge graph, and then flowing from left to right in the knowledge graph.

Beginning with the prime number 2, processing circuit 310 assigns unique, contiguous, and still available (not yet assigned) prime numbers to the full tokens list. In the illustrated implementation, processing circuit 310 respectively assigns the prime numbers 2, 3, 5, 7, 11, 13 to the tokens “Ocean Life,” “Animals,” “Plants,” “Sharks,” “Manatees,” and “Seagrass.” Next, processing circuit 310 generates a product for each token by multiplying the assigned prime number of a corresponding superset that includes the token and the assigned prime number of the token. For token “Ocean Life,” there is no corresponding superset, so the integer 1 is used. The assigned prime number for token “Ocean Life” is 2. Therefore, the product is 2 (1×2 is 2). For token “Animals,” the assigned prime number of the first corresponding superset (superset “Ocean Life”) is 2. The assigned prime number of token “Animals” is 3. Therefore, the product is 6 (2×3 is 6).

For token “Sharks,” the assigned prime number of the first corresponding superset (superset “Animals”) is 3. The assigned prime number of the second corresponding superset (superset “Ocean Life”) is 2. The assigned prime number for token “Sharks” is 7. Therefore, the product is 42 (2×3×7 is 42). It is noted that token “Sharks” is included in both superset “Animals” and superset “Ocean Life.” Processing circuit 310 generates the products for the other tokens in a similar manner. The products are the encoded values for the tokens of the full tokens list. As shown, the full tokens list is {“Ocean Life,” “Animals,” “Plants,” “Sharks,” “Manatees,” “Seagrass”} and the encoded full tokens list is {2, 6, 10, 42, 66, 130}.

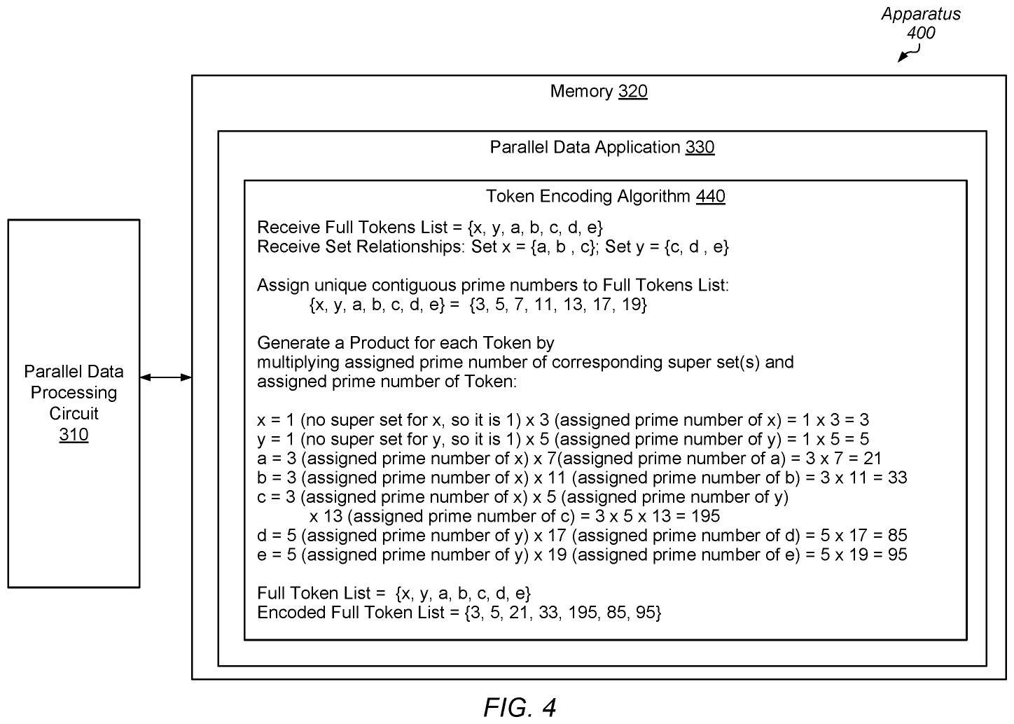

Referring to FIG. 4, a generalized diagram is shown of an apparatus 400 for efficiently encoding tokens of a knowledge graph. Circuitry and components previously described are numbered identically. Parallel data application 330 includes multiple algorithms such as token encoding algorithm 440. When parallel data processing circuit 310 executes the instructions (or translated commands) of token encoding algorithm 440, parallel data processing circuit 310 receives a full tokens list and the corresponding set relationships and generates an encoded full token list relying on prime numbers. In the illustrated implementation, parallel data processing circuit 310 (or processing circuit 310) receives the full tokens list that includes tokens x, y, a, b, c, d and e. These single letter tokens represent any text token to be used in a data model such as a large language model (LLM) or other. In the illustrated implementation, processing circuit 310 receives set relationships that include a superset named “x” that includes the tokens a, b and c (x={a, b, c}). The received set relationships also include a superset named “y” that includes the tokens c, d and e (y={c, d, e}). Beginning with the prime number 3, processing circuit 310 assigns unique, contiguous, and still available (not yet assigned) prime numbers to the full tokens list. In the illustrated implementation, processing circuit 310 assigns the prime numbers 3, 5, 7, 11, 13, 17 and 19 to the tokens x, y, a, b, c, d and e, respectively.

Next, processing circuit 310 generates a product for each token by multiplying the assigned prime number of a corresponding superset that includes the token and the assigned prime number of the token. For token “x”, there is no corresponding superset, so the integer 1 is used. The assigned prime number for token “x” is 3. Therefore, the product is 3 (1×3 is 3). For token a, the assigned prime number of the corresponding superset (superset x) is 3. The assigned prime number for token “a” is 7. Therefore, the product is 21 (3×7 is 21). For token d, the assigned prime number of the corresponding superset (superset y) is 5. The assigned prime number for token “d” is 17. Therefore, the product is 85 (5×17 is 85). It is noted that token “c” is included in both superset x and superset y.

For token c, the assigned prime number of the first corresponding superset (superset x) is 3. The assigned prime number of the second corresponding superset (superset y) is 5. The assigned prime number for token “c” is 13. Therefore, the product is 195 (3×5×13 is 195). Processing circuit 310 generates the products for the other tokens in a similar manner. The products are the encoded values for the tokens of the full tokens list. As shown, the full tokens list is {x, y, a, b, c, d, e} and the encoded full tokens list is {3, 5, 21, 33, 195, 85, 95}.

It is noted that token full lists can be updated over time such as being expanded or being reduced. In an implementation, when parallel data processing circuit 310 executes the instructions (or translated commands) of token encoding algorithm 440, parallel data processing circuit 310 receives a full tokens list that includes tokens J, K and L belonging to no superset yet. These single letter tokens represent any text token to be used in a data model such as a large language model (LLM) or other. Beginning with the prime number 3, processing circuit 310 assigns unique, contiguous, and still available (not yet assigned) prime numbers to the full tokens list. In this implementation, processing circuit 310 respectively assigns the prime numbers 3, 5 and 7 to the set containing tokens J, K and L. Since there is no superset, each of the tokens J, K and L has an encoded value equal to a product of the integer 1 multiplied by the corresponding assigned prime number. Therefore, in this implementation, the full tokens list is {J, K, L} and the encoded full tokens list is {3, 5, 7}.

At a later time, when the corresponding knowledge graph expands and a new token M is added, and the new token M is a leaf element of the knowledge graph, processing circuit 310 assigns the next unique, contiguous, and still available (not yet assigned) prime number, such as prime number 11, to token M. Since there is no superset, each of the tokens J, K, Land M has an encoded value equal to a product of the integer 1 multiplied by the corresponding assigned prime number. Therefore, in this implementation, the full tokens list is {J, K, L, M} and the encoded full tokens list is {3, 5, 7, 11}. However, if the corresponding knowledge graph expands and a new token N is added, and the new token N is a non-leaf element of the knowledge graph, then N is a superset. In this implementation, the superset N includes the tokens J, K and L (N={J, K, L}). The processing circuit 310 assigns the next unique, contiguous, and still available (not yet assigned) prime number, such as prime number 11, to token N. Since token N is a superset, each of the tokens J, K and L has an encoded value equal to a product of the assigned prime number of the superset N multiplied by the corresponding assigned prime number. For example, Therefore, in this implementation, the encoded value for token J is 33 (11×3 is 33). Accordingly, the full tokens list is {J, K, L, N} and the encoded full tokens list is {33, 55, 77, 11}.

Continuing with the full tokens list of {J, K, L, M} and the corresponding encoded full tokens list of {3, 5, 7, 11}, it is possible that the corresponding knowledge graph shrinks, and the token M is removed. Since the token M is a leaf element of the knowledge graph, the assigned prime number of 11 is freed and returned to a free list of available prime numbers for assignment to tokens. In addition, the encoded values of the other tokens J, K and L are unaffected. Therefore, in this implementation, after the token removal for token M, the full tokens list is {J, K, L} and the encoded full tokens list is {3, 5, 7}. The other full tokens list includes {J, K, L, N}. Here, N is a superset (N={J, K, L}). Continuing with the other full tokens list of {J, K, L, N} and the corresponding encoded full tokens list of {33, 55, 77, 11}, it is possible that the corresponding knowledge graph shrinks, and the token N is removed. Since the token N is a non-leaf element of the knowledge graph and a superset that includes the other tokens (J, K, L), the assigned prime number of 11 is freed and returned to a free list of available prime numbers for assignment to tokens. In addition, the encoded values of the other tokens J, K and L updated by dividing the presently used encoded value by the prime number 11 of token N. Therefore, in this implementation, after the token removal for token N, the full tokens list is {J, K, L} and the encoded full tokens list is {3, 5, 7}.

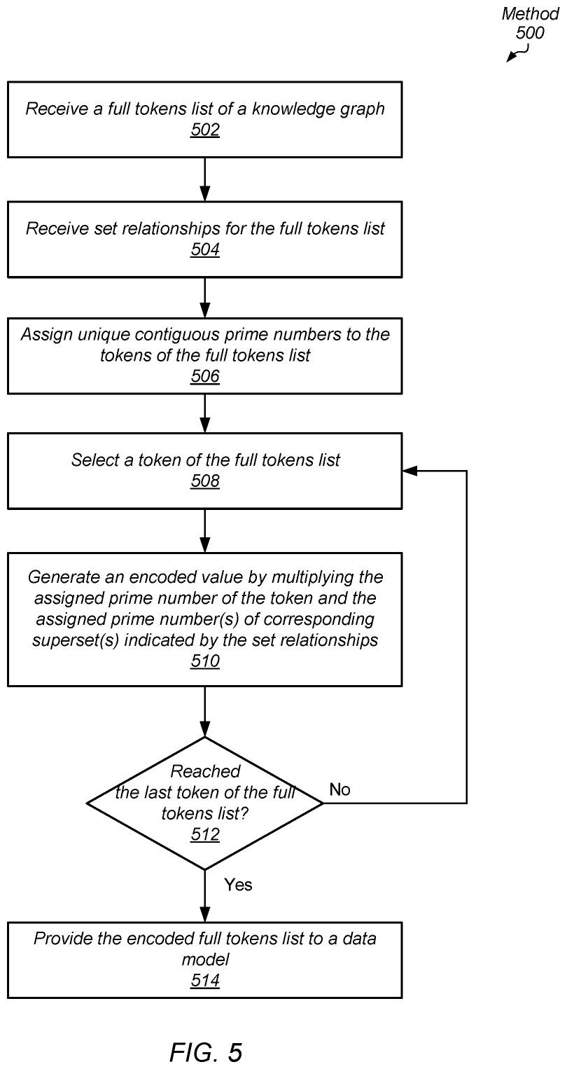

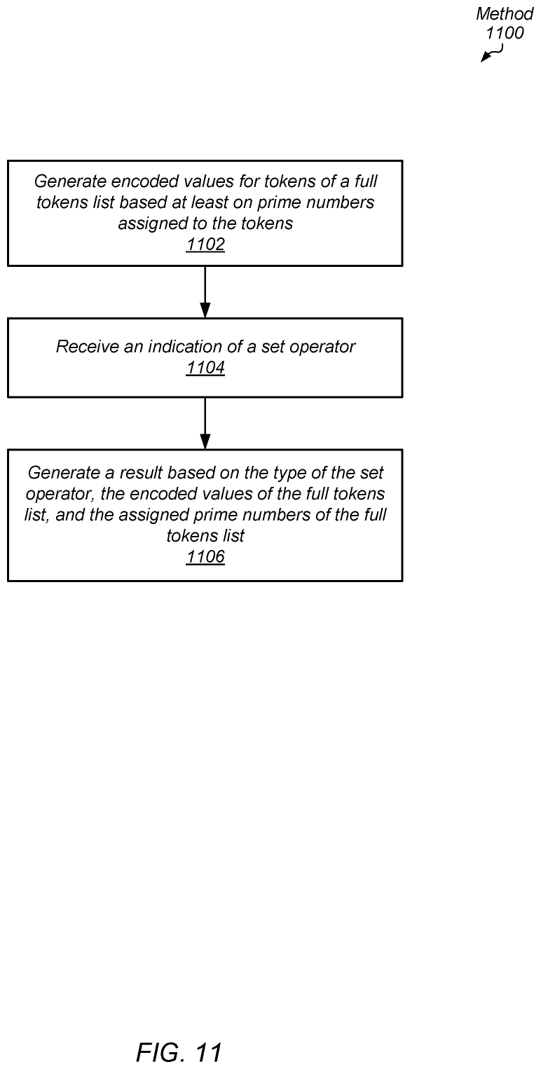

Referring to FIG. 5, a generalized diagram is shown of a method 500 for efficiently encoding tokens of a knowledge graph. For purposes of discussion, the steps in this implementation (as well as FIG. 11) are shown in sequential order. However, in other implementations some steps occur in a different order than shown, some steps are performed concurrently, some steps are combined with other steps, and some steps are absent.

A computing system includes at least a parallel data processing circuit and a memory. The parallel data processing circuit uses a parallel data microarchitecture such as a single instruction multiple data (SIMD) parallel microarchitecture. Examples of the parallel data processing circuit are a graphics processing unit (GPU), a digital signal processing circuit (DSP), a field programmable gate array (FPGA), an application specific integrated circuit (ASIC), and so forth. In some implementations, a general-purpose processing circuit translates instructions of parallel data function calls of an application to commands that are executable by the parallel data processing circuit. The memory stores at least the instructions (or translated commands) of a parallel data application that relies on a data model such as a large language model (LLM). The parallel data application includes a token encoding algorithm. The parallel data processing circuit receives a full tokens list of a knowledge graph (block 502). The parallel data processing circuit also receives set relationships for the full tokens list (block 504).

When the parallel data processing circuit executes the instructions (or translated commands) of the token encoding algorithm of the parallel data application, the parallel data processing circuit assigns unique contiguous prime numbers to the tokens of the full tokens list (block 506). The parallel data processing circuit (or processing circuit) selects a token from the full tokens list (block 508). The processing circuit generates an encoded value by multiplying the assigned prime number of the token and the assigned prime number(s) of corresponding superset(s) indicated by the set relationships (block 510).

If the last token of the full tokens list has not yet been reached (“no” branch of the conditional block 512), then control flow of method 500 returns to block 508 where the processing circuit selects a token of the full tokens list. If the last token of the full tokens list has been reached (“yes” branch of the conditional block 512), then the processing circuit provides the encoded full tokens list to the data model (block 514).

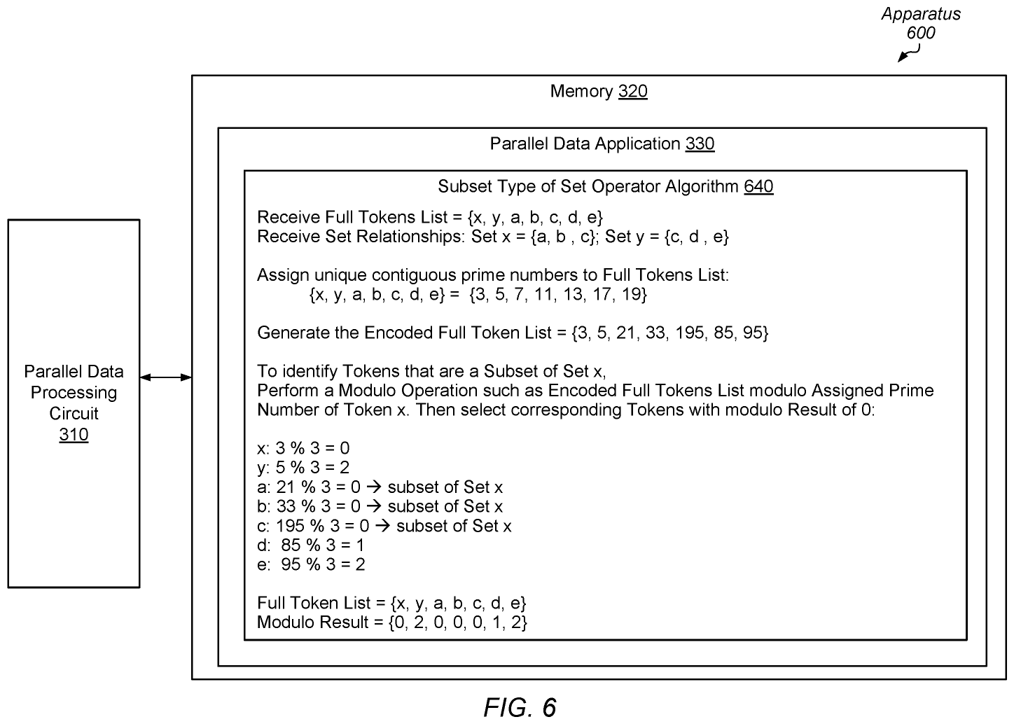

Referring to FIG. 6, a generalized diagram is shown of an apparatus 600 that performs a subset type of set operation with efficiently encoded tokens of a knowledge graph. Circuitry and components previously described are numbered identically. Parallel data application 330 includes multiple algorithms such as a subset type of set operation algorithm 640. When parallel data processing circuit 310 (or processing circuit 310) executes the instructions (or translated commands) of algorithm 640, processing circuit 310 receives the full tokens list that includes tokens x, y, a, b, c, d and e, and receives set relationships that include a superset named “x” that includes the tokens a, b and c (x={a, b, c}). The received set relationships also include a superset named “y” that includes the tokens c, d and e (y={c, d, e}). When executing the instructions of algorithm 640, processing circuit 310 uses the set relationships as described earlier to respectively assign unique prime numbers to the tokens of the full tokens list such as assigning the prime numbers 3, 5, 21, 33, 195, 85 and 95 to the tokens x, y, a, b, c, d and e. When executing the instructions of algorithm 640, processing circuit 310 generates an indication specifying whether token “a” is a subset of set x. To do so, processing circuit 310 generates a result of the encoded value of token “a” (21) modulo the assigned prime number of token x (3). This modulo operation provides {21} % {3}, and the result is 0. Therefore, token “a” is in the subset of set x. Processing circuit 310 performs the same operations with the other tokens.

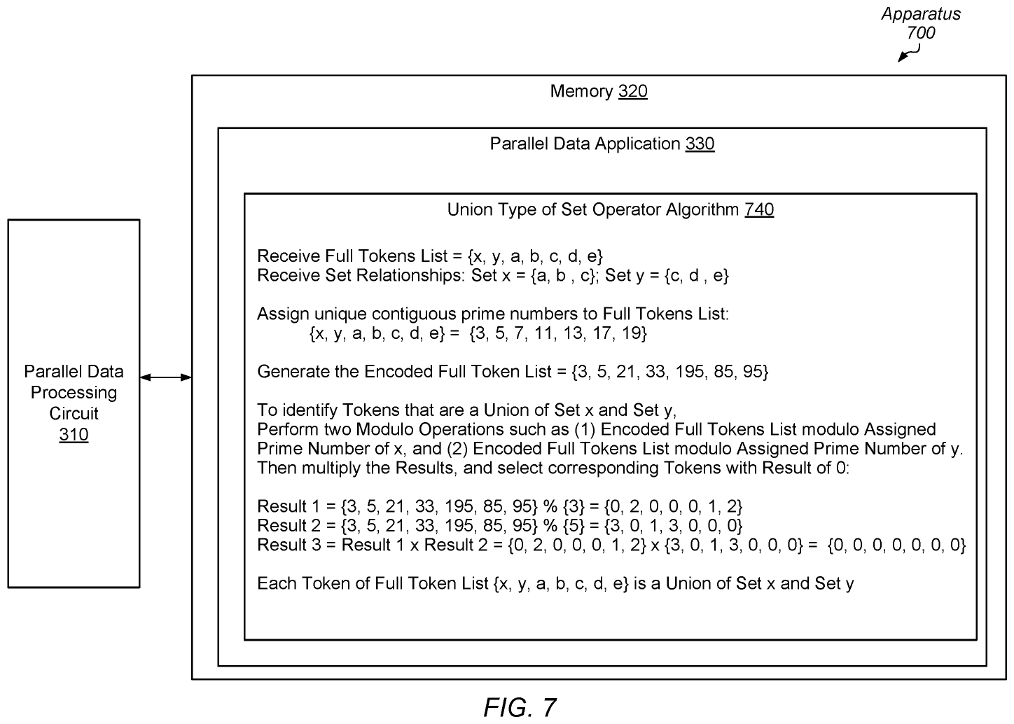

Turning now to FIG. 7, a generalized diagram is shown of an apparatus 700 that performs a union type of set operation with efficiently encoded tokens of a knowledge graph. Circuitry and components previously described are numbered identically. Parallel data application 330 includes multiple algorithms such as a union type of set operation algorithm 740. When executing the instructions of algorithm 740, processing circuit 310 generates an indication specifying whether token “a” is in a union of set x and set y. To do so, processing circuit 310 generates a first result of the encoded value of token “a” (21) modulo the assigned prime number of token x (3). This modulo operation provides {21} % {3}, and the result is 0. Processing circuit 310 generates a second result of the encoded value of token “a” (21) modulo the assigned prime number of token y (5). This modulo operation provides {21} % {5}, and the result is 1. Processing circuit 310 generates a third result by generating a multiplicative product of the first result and the second result. The third result is 0. Therefore, token “a” is in the union of set x and set y. Processing circuit 310 performs the same operations with the other tokens.

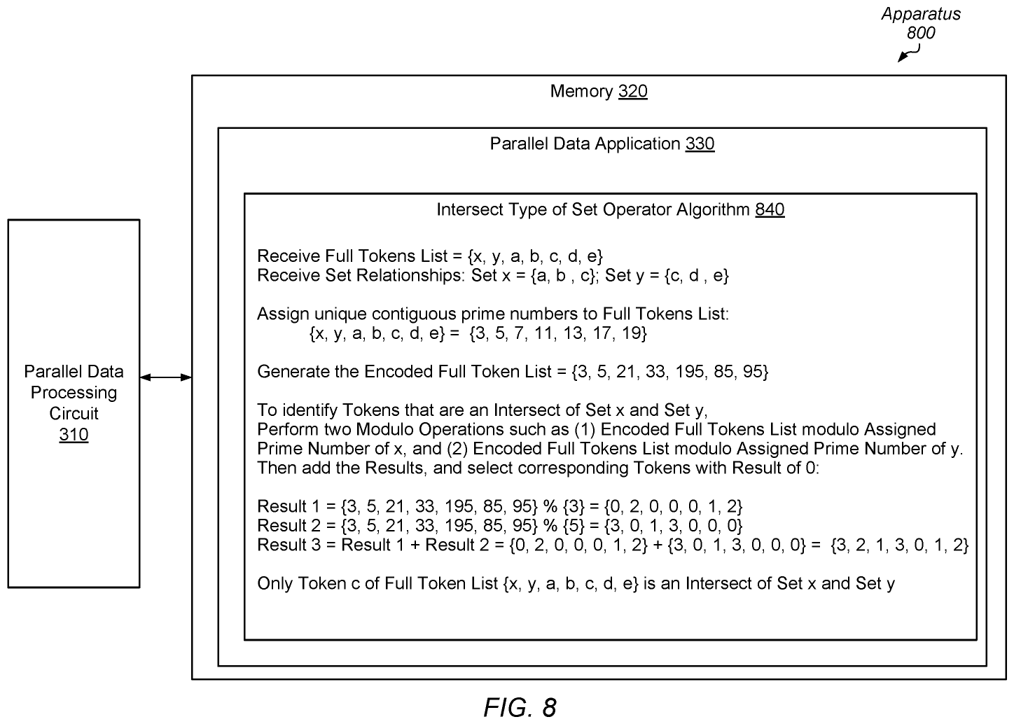

Referring to FIG. 8, a generalized diagram is shown of an apparatus 800 that performs an intersect type of set operation with efficiently encoded tokens of a knowledge graph. Circuitry and components previously described are numbered identically. Parallel data application 330 includes multiple algorithms such as an intersect type of set operation algorithm 840. When executing the instructions of algorithm 840, processing circuit 310 generates an indication specifying whether token “a” is in an intersect (or intersection) of set x and set y. To do so, processing circuit 310 generates a first result of the encoded value of token “a” (21) modulo the assigned prime number of token x (3). This modulo operation provides {21} % {3}, and the result is 0. Processing circuit 310 generates a second result of the encoded value of token “a” (21) modulo the assigned prime number of token y (5). This modulo operation provides {21} % {5}, and the result is 1. Processing circuit 310 generates a third result by generating a sum of the first result and the second result. The third result is 1. Therefore, token “a” is not in the intersect of set x and set y. Processing circuit 310 performs the same operations with the other tokens. As shown, token “c” is in the intersect of set x and set y.

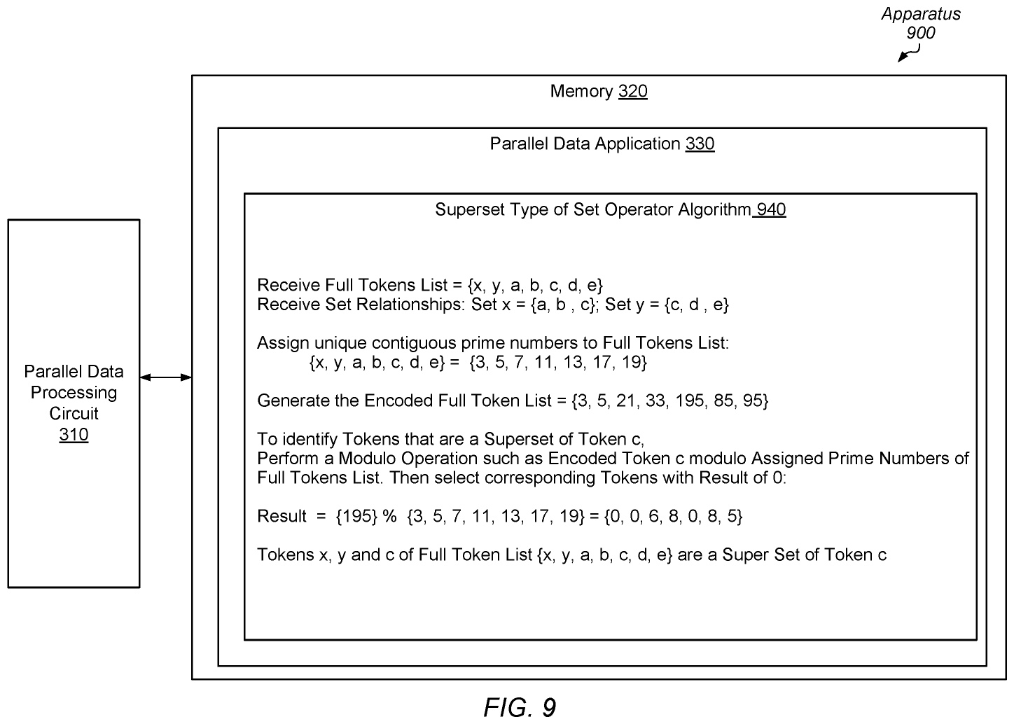

Referring to FIG. 9, a generalized diagram is shown of an apparatus 900 that performs a superset type of set operation with efficiently encoding tokens of a knowledge graph. Circuitry and components previously described are numbered identically. Parallel data application 330 includes multiple algorithms such as a superset type of set operation algorithm 940. When executing the instructions of algorithm 940, processing circuit 310 generates an indication specifying which tokens are in a superset of token “c”. To determine whether token “a” is in a superset of token “c”, processing circuit 310 generates the result of the encoded value of token “c” (195) modulo the assigned prime number of token “a” (7). This modulo operation provides {195} % {7}, and the result is 6. Since the result is not zero, token “a” is not in the superset of token c. Processing circuit 310 performs the same operations with the other tokens. As shown, token “x” (and token “y”) is in the superset of token “c”.

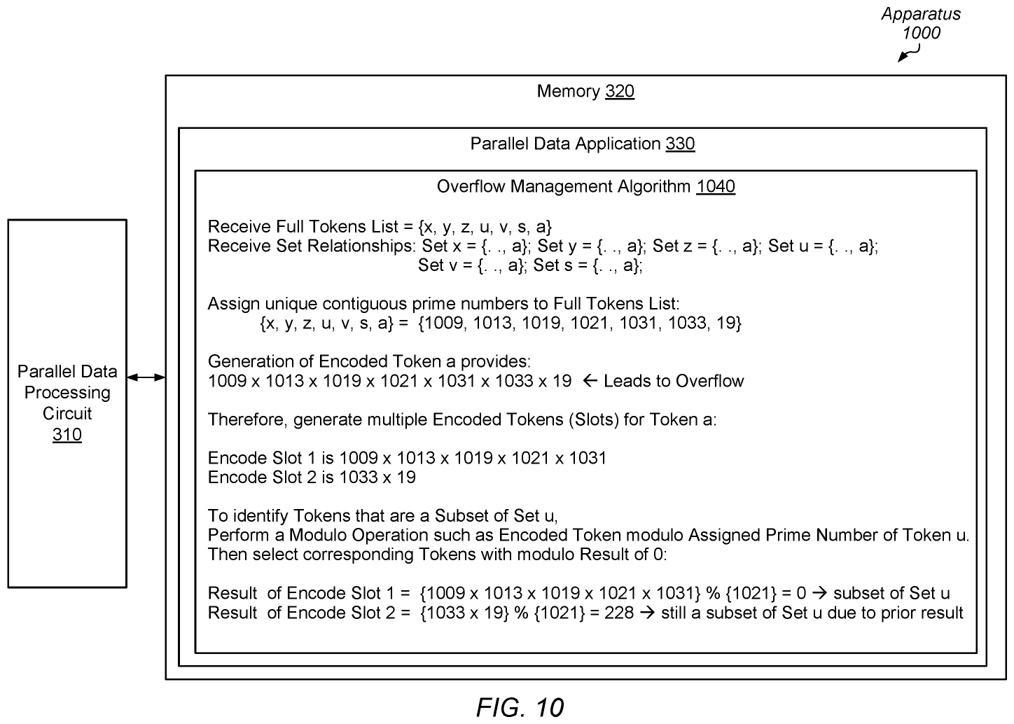

Referring to FIG. 10, a generalized diagram is shown of an apparatus 1000 that performs overflow management with efficiently encoded tokens of a knowledge graph. Circuitry and components previously described are numbered identically. Parallel data application 330 includes multiple algorithms such as overflow management algorithm 1040. When parallel data processing circuit 310 executes the instructions (or translated commands) of overflow management algorithm 1040, parallel data processing circuit 310 monitors the sizes of the assigned prime numbers, the sizes of the generated encoding values, and the sizes of the register storing these values. In the illustrated implementation, the received full tokens list includes seven tokens {x, y, z, u, v, s, a} where the token “a” is included in each of six supersets of the full tokens list. Based on the assigned prime numbers in the illustrated implementation, the generation of the encoded value for token “a” provides the value (1009×1013×1019×1021×1031×1033×19). This encoded value causes an overflow condition.

To avoid overflow, the processing circuit divides the encoded value into two separate values referred to as slots. The first encoded slot (slot 1) includes the value (1009×1013×1019×1021×1031), and the second encoded slot (slot 2) includes the value (1033×19). As an example of performing a set operation with two encoded slots, the processing circuit 310 generates an indication specifying whether token “a” is a subset of set u. To do so, processing circuit 310 generates a result of the encoded slot 1 modulo the assigned prime number of token u. This modulo operation provides {1009×1013×1019×1021×1031} % {1021}, and the result is 0. Processing circuit 310 generates another result of the encoded slot 2 modulo the assigned prime number of token u. This modulo operation provides {1033×19} % {1021}, and the result is 228. The second result is not 0, but the first result is 0. Therefore, token “a” is in the subset of set u.

Referring to FIG. 11, a generalized diagram is shown of a method 1100 for efficiently encoding tokens of a knowledge graph. A parallel data processing circuit receives a full tokens list of a knowledge graph and receives set relationships for the full tokens list. The processing circuit generates encoded values for tokens of a full tokens list based at least on prime numbers assigned to the tokens (block 1102). The processing circuit Receive an indication of a set operator (block 1104). The processing circuit generates a result based on the type of the set operator, the encoded values of the full tokens list, and the assigned prime numbers of the full tokens list (block 1106). Examples of the set operations are a union operation, an intersect (or intersection) operation, a subset operation, and a superset operation. By encoding the tokens based on unique contiguous prime numbers, the processing circuit additionally encodes the relationships, rather than providing separate encoded values for edges of the knowledge graph. Consequently, the processing circuit is able perform the set operations with the encoded values in a parallel manner.

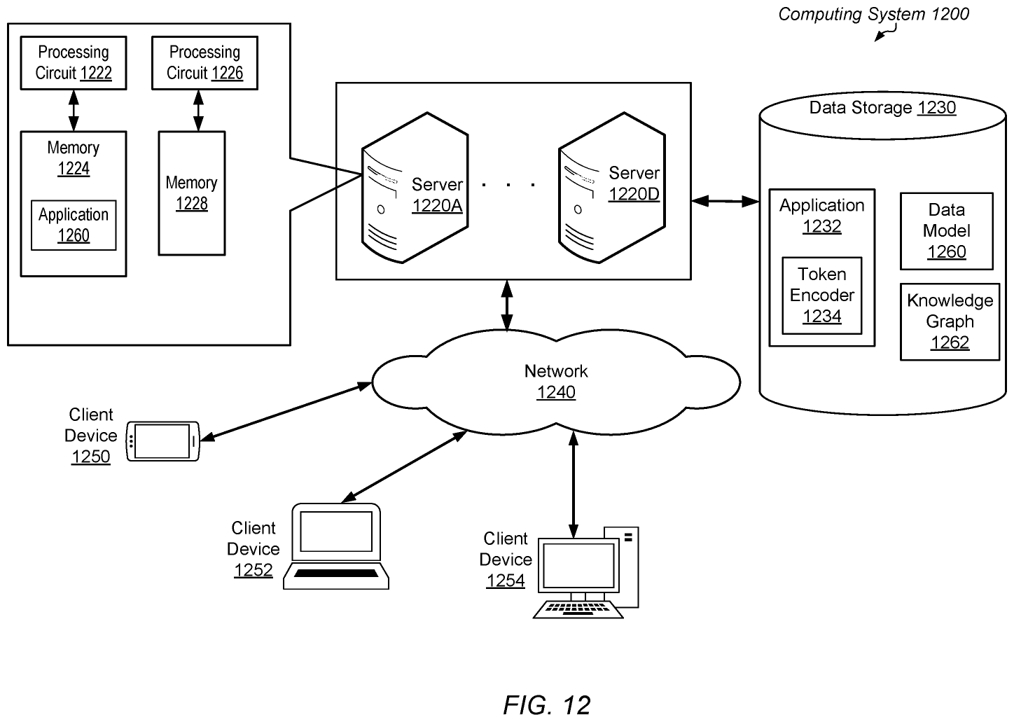

Turning now to FIG. 12, a generalized diagram is shown of a computing system 1200 that efficiently encodes tokens of a knowledge graph. In the illustrated implementation, computing system 1200 includes multiple client devices 1250, 1252 and 1254, a network 1240, the servers 1220A-1220D, and the data storage 1230. Data storage 1230 includes a copy of an application 1232 that uses a token encoder 1234. Data storage 1230 also includes data model 1260 and knowledge graph 1262. In some implementations, data model 1260 is a multilayer network such as a large language model (LLM).

Application 1232 includes instructions that perform one or more set operations on tokens of knowledge graph 1262. Examples of the set operations are a union operation, an intersect (or intersection) operation, a subset operation, and a superset operation. The token encoder 1234 encodes the tokens of knowledge graph 1262 using prime numbers. By encoding the tokens based on unique contiguous prime numbers, token encoder 1234 additionally encodes the relationships, rather than providing separate encoded values for edges of the knowledge graph. Consequently, one of the processing circuits 1222 and 1226 is able perform the set operations with the encoded values in a parallel manner.

As shown, server 1220A includes a processing circuit 1222 that accesses memory 1224 to process tasks, and the processing circuit 1226 that accesses memory 1228 to process tasks. Application 1225 is a copy of application 1232 that includes token encoder 1234. Although three client devices 1250, 1252 and 1254 are shown, any number of client devices access applications run on the servers 1220A-1220D. For example, server 1220A stores the application 1225 in memory 1224, which is a copy of the application 1232 stored in the data storage 1230. Examples of the client devices 1250, 1252 and 1254 are a laptop computer, a smartphone, a gaming console connected to a television, a tablet computer, a desktop computer, or other.

Client devices 1250, 1252 and 1254 execute one of a variety of available World Wide Web browsers. The user searches, or “browses”, sites on the World Wide Web (“Web”) via Web browsers being executed on the client device. The user accesses Web pages for a variety of reasons such as performing business transactions, reading about news and current events, communicating through social networking sites, downloading entertainment content, performing research, and so forth.

Clock sources, such as phase lock loops (PLLs), an interrupt controller, a communication fabric, power controllers, memory controllers, interfaces for input/output (I/O) devices, and so forth are not shown in the computing system 1200 for ease of illustration. It is also noted that the number of components of the computing system 1200 and the number of subcomponents for those shown in FIG. 12 can vary from implementation to implementation. There can be more or fewer of each component/subcomponent than the number shown for the computing system 1200.

In various implementations, the client devices 1250, 1252 and 1254 include a network interface (not shown) supporting one or more communication protocols for data and message transfers through the network 1240. Network 1240 includes multiple switches, routers, cables, wireless transmitters, and the Internet for transferring messages and data. Accordingly, the network interface of the client device 1250 supports one or more of the Hypertext Transfer Protocol (HTTP), the Transmission Control Protocol (TCP), the User Datagram Protocol (UDP), or another protocol for communication across the World Wide Web.

In some implementations, an organizational center (not shown) maintains application 1232. In addition to communicating with the client devices 1250, 1252 and 1254 through the network 1240, the organizational center also communicates with the data storage 1230 for storing and retrieving data. The data storage 1230 includes one or more of a variety of hard disk drives and solid-state drives for data storage. Through user authentication, users are able to access resources through the organizational center to update user profile information, access a history of purchases or other accessed content, and download content.

In various implementations, processing circuit 1222 has the functionality of a general-purpose processing circuit that translates instructions to commands for processing circuit 1226, and processing circuit 1226 has the same functionality described earlier for processing circuit 310 (of FIG. 3). The servers 1220A-1220D include a variety of server types such as database servers, computing servers, application servers, file servers, mail servers, cloud-based servers, and so on. In various implementations, the servers 1220A-1220D and the client devices 1250, 1252 and 1254 operate with a client-server architectural model. In various implementations, application 1232 is one of a variety of types of parallel data applications.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A non-transitory computer readable medium comprising program instructions executable by circuitry to:
receive a plurality of tokens of a knowledge graph;
assign a corresponding prime number to each of the plurality of tokens; and
generate a plurality of encoded values, each based at least in part on one of the plurality of tokens and a prime number assigned to the one of the plurality of tokens.

2. The non-transitory computer readable medium as recited in claim 1, wherein the circuitry is further configured to generate a first encoded value of the plurality of encoded values of a first token of the plurality of tokens by multiplying a prime number assigned to the first token by a prime number assigned to a second token that is a superset comprising the first token.

3. The non-transitory computer readable medium as recited in claim 2, wherein the circuitry is further configured to receive set relationships corresponding to the plurality of tokens that specify which tokens are superset tokens and which tokens of the plurality of tokens are comprised within a superset token.

4. The non-transitory computer readable medium as recited in claim 2, wherein the circuitry is further configured to:
generate a first result of the first encoded value of the plurality of encoded values modulo a third token of the plurality of tokens; and
generate an indication specifying the first token is in a subset of a set of the third token, responsive to the first result is zero.

5. The non-transitory computer readable medium as recited in claim 4, wherein the circuitry is further configured to:
generate a second result of the first encoded value of the plurality of encoded values modulo a fourth token of the plurality of tokens; and
generate an indication specifying the first token is in a union of the set of the third token and a set of the fourth token, responsive to a multiplicative product of the first result and the second result is zero.

6. The non-transitory computer readable medium as recited in claim 4, wherein the circuitry is further configured to:
generate a second result of the first encoded value of the plurality of encoded values modulo a fourth token of the plurality of tokens; and
generate an indication specifying the first token is in an intersect of the set of the third token and a set of the fourth token, responsive to a sum of the first result and the second result is zero.

7. The non-transitory computer readable medium as recited in claim 2, wherein the circuitry is further configured to:
generate a result of an encoded value of a third token of the plurality of tokens modulo an assigned prime number of a fourth token of the plurality of tokens; and
generate an indication specifying the fourth token is in a superset of the third token, responsive to the result is zero.

8. A method, comprising:
receiving, by circuitry of a processing circuit, a plurality of tokens of a knowledge graph;
assigning, by the circuitry, a corresponding prime number to each of the plurality of tokens; and
generating, by the circuitry, a plurality of encoded values, each based at least in part on one of the plurality of tokens and a prime number assigned to the one of the plurality of tokens.

9. The method as recited in claim 8, further comprising generating a first encoded value of the plurality of encoded values of a first token of the plurality of tokens by multiplying a prime number assigned to the first token by a prime number assigned to a second token that is a superset comprising the first token.

10. The method as recited in claim 9, further comprising receiving set relationships corresponding to the plurality of tokens that specify which tokens are superset tokens and which tokens of the plurality of tokens are comprised within a superset token.

11. The method as recited in claim 9, further comprising:
generating a first result of the first encoded value of the plurality of encoded values modulo a third token of the plurality of tokens; and
generating an indication specifying the first token is in a subset of a set of the third token, responsive to the first result is zero.

12. The method as recited in claim 11, further comprising:
generating a second result of the first encoded value of the plurality of encoded values modulo a fourth token of the plurality of tokens; and
generating an indication specifying the first token is in a union of the set of the third token and a set of the fourth token, responsive to a multiplicative product of the first result and the second result is zero.

13. The method as recited in claim 11, further comprising:
generating a second result of the first encoded value of the plurality of encoded values modulo a fourth token of the plurality of tokens; and
generating an indication specifying the first token is in an intersect of the set of the third token and a set of the fourth token, responsive to a sum of the first result and the second result is zero.

14. The method as recited in claim 9, further comprising:
generating a result of an encoded value of a third token of the plurality of tokens modulo an assigned prime number of a fourth token of the plurality of tokens; and
generating an indication specifying the fourth token is in a superset of the third token, responsive to the result is zero.

15. An apparatus comprising:
circuitry configured to:
receive a plurality of tokens of a knowledge graph;
assign a corresponding prime number to each of the plurality of tokens; and
generate a plurality of encoded values, each based at least in part on one of the plurality of tokens and a prime number assigned to the one of the plurality of tokens.

16. The apparatus as recited in claim 15, wherein the circuitry is further configured to generate a first encoded value of the plurality of encoded values of a first token of the plurality of tokens by multiplying a prime number assigned to the first token by a prime number assigned to a second token that is a superset comprising the first token.

17. The apparatus as recited in claim 16, wherein the circuitry is further configured to receive set relationships corresponding to the plurality of tokens that specify which tokens are superset tokens and which tokens of the plurality of tokens are comprised within a superset token.

18. The apparatus as recited in claim 16, wherein the circuitry is further configured to:
generate a first result of the first encoded value of the plurality of encoded values modulo a third token of the plurality of tokens; and
generate an indication specifying the first token is in a subset of a set of the third token, responsive to the first result is zero.

19. The apparatus as recited in claim 18, wherein the circuitry is further configured to:
generate a second result of the first encoded value of the plurality of encoded values modulo a fourth token of the plurality of tokens; and
generate an indication specifying the first token is in a union of the set of the third token and a set of the fourth token, responsive to a multiplicative product of the first result and the second result is zero.

20. The apparatus as recited in claim 18, wherein the circuitry is further configured to:
generate a second result of the first encoded value of the plurality of encoded values modulo a fourth token of the plurality of tokens; and
generate an indication specifying the first token is in an intersect of the set of the third token and a set of the fourth token, responsive to a sum of the first result and the second result is zero.
